(19) United States
(12) Patent Application Publication
(10) Pub. No.: US 2014/0211093 A1
(43) Pub. Date: Jul. 31, 2014

(54) USER INTERFACE SYSTEM AND METHOD FOR PROVIDING TELEVISION PROGRAM SCHEDULE

(71) Applicant: HON HAI PRECISION INDUSTRY CO., LTD., New Taipei (TW)

(72) Inventor: SHU-PING LIU, New Taipei (TW)

(73) Assignee: HON HAI PRECISION INDUSTRY CO., LTD., New Taipei (TW)

(21) Appl. No.: 14/158,887

(22) Filed: Jan. 20, 2014

(30) Foreign Application Priority Data
Jan. 29, 2013 (TW) 102103263

(51) Int. Cl. H04N 5/445; H04N 21/482; H04N 21/431; H04N 5/50

(52) U.S. Cl. CPC H04N 5/44543; H04N 5/50; H04N 21/4821; H04N 21/4312
USPC 348/570

(57) ABSTRACT

A user interface system is executed by a television for generating a program schedule. The user interface system includes a storage module, a searching module, and a generating module. The storage module stores a number of channel numbers and a number of channel logos corresponding to the channel numbers. The searching module searches for television channels. Each television channel corresponds to one channel number and one channel logo. The generating module combines each channel logo with the respective channel number to generate channel symbols according to a predetermined rule, arranges the channel symbols according to a predetermined pattern to generate a program schedule, and displays the program schedule in response to a user's commands.

### BACKGROUND

1. Technical Field

The present disclosure relates to user interface managing technology, and particularly to a user interface system and method for providing a program schedule for a television.

2. Description of Related Art

Most Digital televisions display a user interface with a program schedule. However, the program schedule generally displays channel numbers and channel names associated with the channel numbers, which may be inconvenient to read when the TV screen is small and the user is sitting at an extended distance from the screen. In addition, It is the cable service provider that is sending the schedule to be displayed so I do not see how a “user” can edit the schedule. Thus, the program schedule cannot satisfy individual requirements of customers.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 shows a schematic view of an embodiment of a television including a user interface system.

FIG. 2 shows function blocks of the user interface system in FIG. 1.

FIG. 3 shows a schematic view of a relationship table of data in a storage of the user interface system.

FIG. 4 shows a television program schedule provided by the user interface system in FIG. 2.

FIG. 5 shows a flowchart of an embodiment of a method for providing a program schedule.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

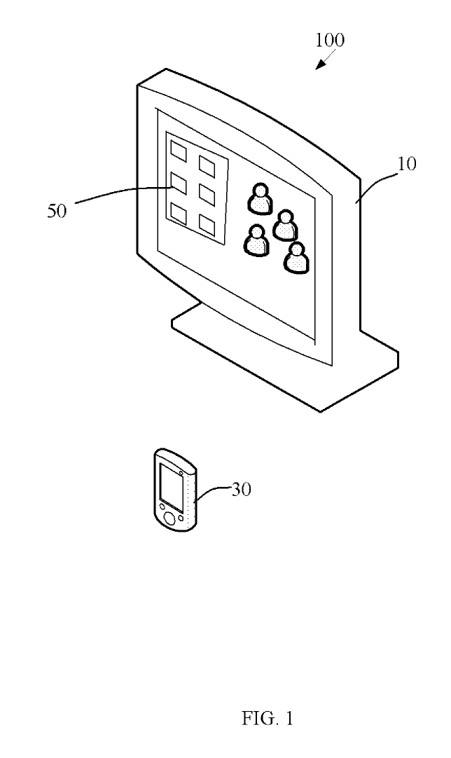

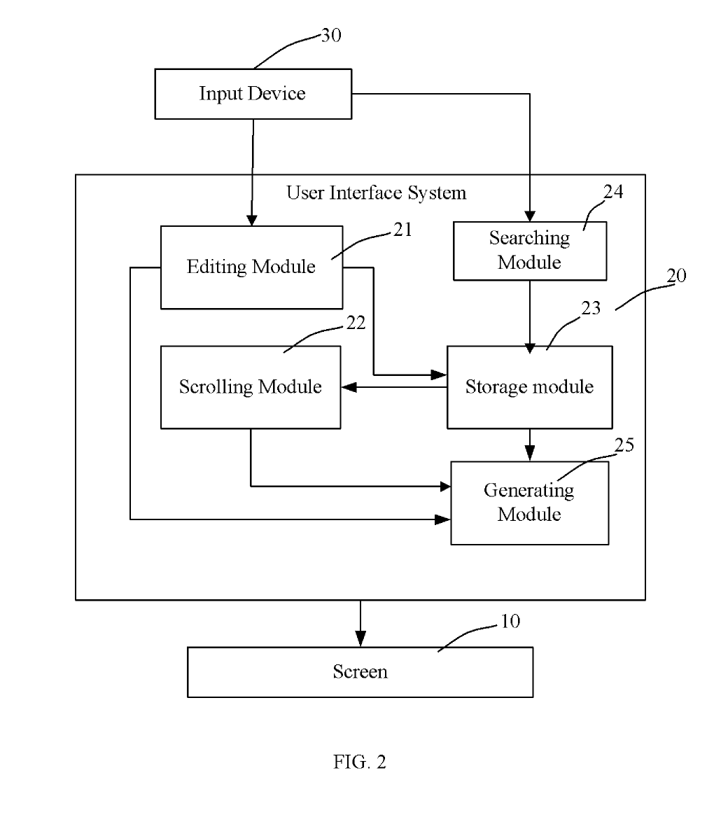

FIGS. 1 and 2 show an embodiment of a television 100. The television 100 includes a display 10, a user interface system 20, and an input device 30. The user interface system 20 generates a program schedule 50 and displays the program schedule 50 on the screen 10. The input device 30 responds to a user's operations to generate corresponding commands. In this embodiment, the input device 30 is a remote controller. In other embodiments, the input device 30 can be hard keys disposed on the television 100, or soft keys displayed on the screen 10.

The user interface system 20 includes an editing module 21, a scrolling module 22, a storage module 23, a generating module 25, and a searching module 24.

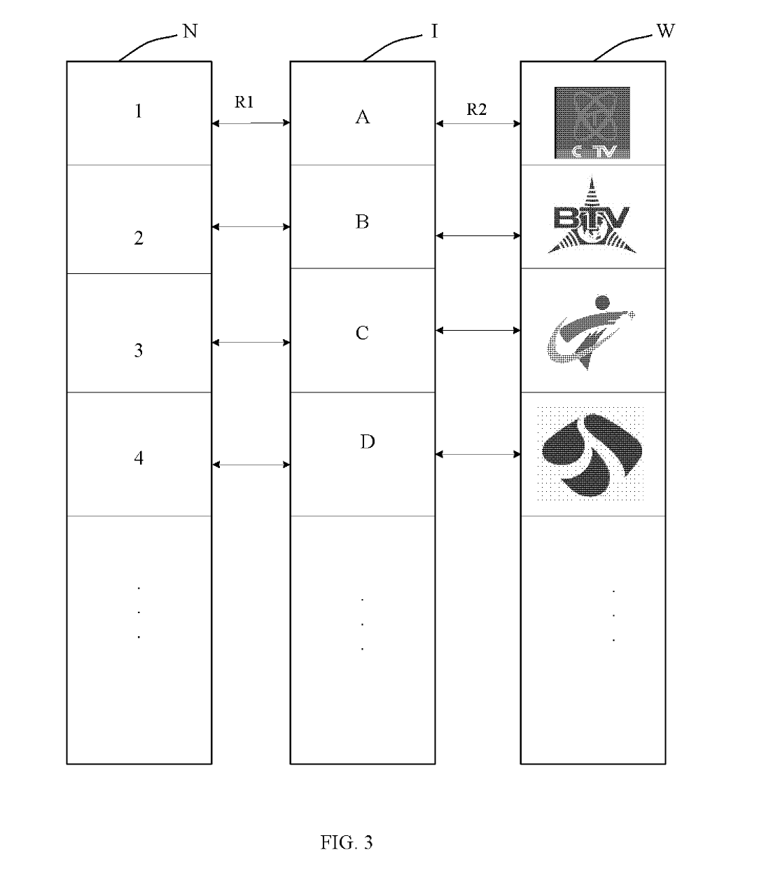

Referring to FIG. 3, the channel searching module 24 searches for television channels in response to the user's corresponding commands. Each television channel includes a channel name I and a channel logo W.

The storage module 23 stores a relationship table, which includes a number of channel numbers N, a number of channel names I, a number of channel logos W, a relationship R1 between the channel numbers N and the respective channel names I, and a relationship R2 between the channel names I and the respective channel logos W. Thus, each channel number N is associated with one corresponding channel name I, and one channel name I is associated with one corresponding channel logo W. In this embodiment, the relationship R1 is generated and stored after the searching module 24 searches for and finds the television channels, and the relationship R2 is pre-stored in the storage module 23.

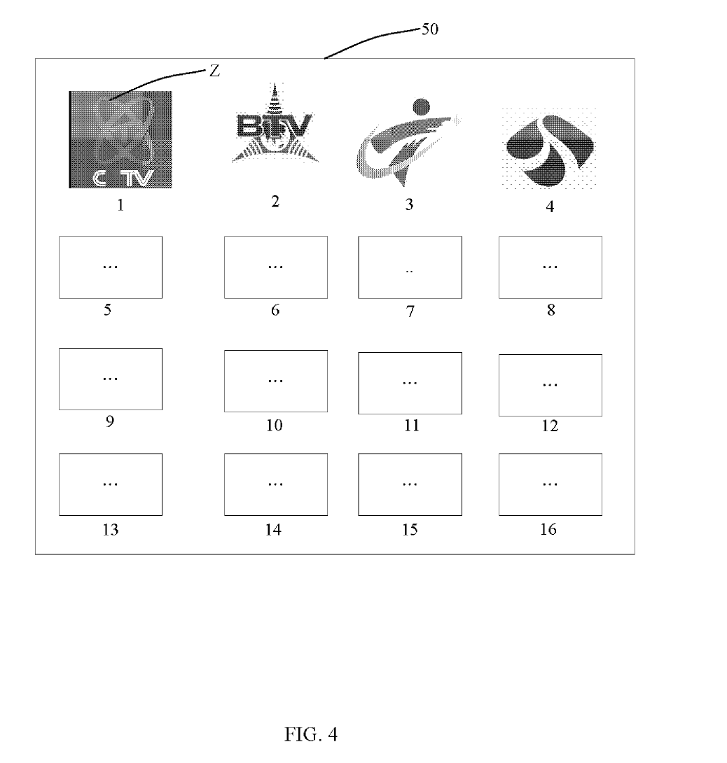

Referring to FIG. 4, the generating module 25 combines each channel logo W with the respective channel number N according to a predetermined rule to form channel symbols Z for indicating the associated television channel. In this embodiment, the channel number N is arranged under the channel logo W. In other embodiments, the channel number N can be arranged inside the channel logo W or other sides of the channel logo W.

The generating module 25 further compiles the generated channel symbols Z into a number of pages. In this embodiment, each page contains sixteen generated channel symbols Z.

The generating module 25 further arranges the generated channel symbols Z of each page into a predetermined matrix to form a program schedule 50, and displays the program schedule 50 on the screen 10 in response to the user's corresponding commands. In the illustrated embodiment, the predetermined matrix is a 4*4 matrix.

The editing module 21 edits the generated channel symbols Z in response to the user's corresponding commands. For example, the channel logo W can be changed, and annotations can be added adjacent to the channel symbols Z.

The editing module 21 further adjusts a layout of the generated channel symbols Z on each page, and a number of the generated channel symbols Z arranged on each page.

The scrolling module 22 controls the program schedule 50 to scroll up or scroll down in response to the user's corresponding commands.

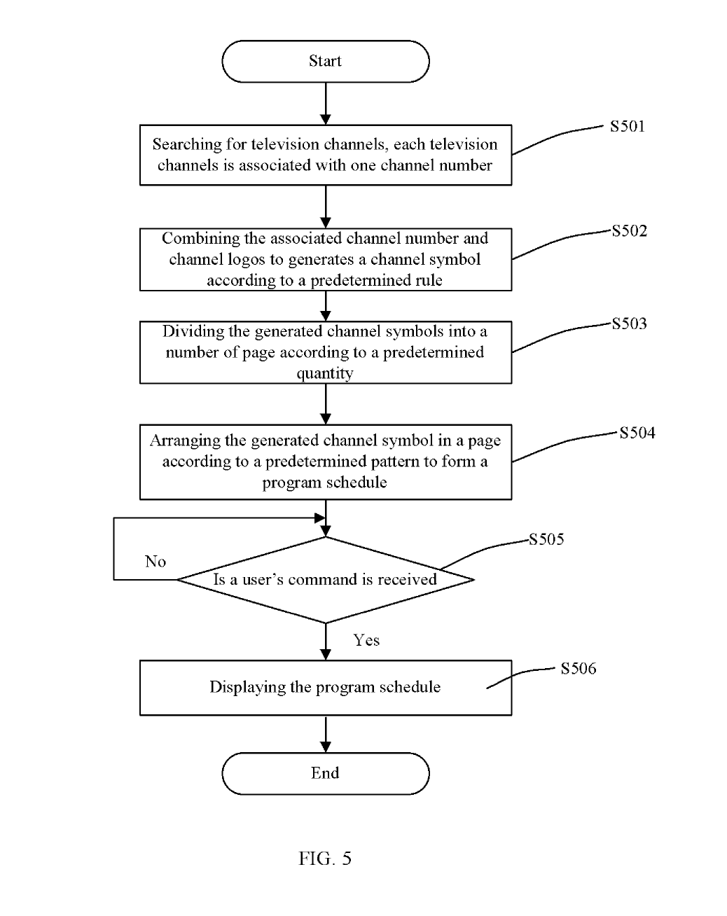

FIG. 5 shows a method for providing the program schedule 50. The method includes the following steps.

Step S501, searching for television channels. Each television channel is associated with one corresponding channel number.

Step S502, combining each channel number with the respective channel logo to generate a channel symbol according to a predetermined rule. In this embodiment, the predetermined rule is arranging the channel number below the channel logo.

Step S503, compiling the generated channel symbols into a number of pages.

Step S504, arranging the generated channel symbols of each page into a predetermined matrix to form a program schedule.

Step S505, determining whether a user's command is received. When the user's command is received, the process goes to step S506. When the user's command is not received, step S505 is repeated.

Step S506, displaying the program schedule.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A user interface system, executed by a television for generating a program schedule, the user interface system comprising:
a storage module to store a plurality of channel numbers and a plurality of channel logos;
a searching module to search for television channels, each television channel corresponding to one channel numbers and one channel logos; and
a generating module to combine each channel logo and the respective channel number to generate channel symbols according to a predetermined rule, arranging the channel symbols according to predetermined patterns to generate a program schedule; and displaying the program schedule in response to a user's corresponding command.

2. The user interface system of claim 1, wherein the predetermined rule is arranging the channel number in or outside the channel logo.

3. The user interface system of claim 1, wherein the generating module further divides the channel symbols in a plurality of pages according to a predetermined quantity.

4. The user interface system of claim 1, wherein the predetermined patterns in different pages are different.

5. The user interface system of claim 1, further comprising an editing module to edit the channel symbol in response to another user's corresponding command.

6. The user interface system of claim 1, further comprising an editing module to add or cancel a text in the channel symbol in response to another user's corresponding command.

7. The user interface system of claim 1, further comprising an editing module to change an order or a quantity of the channel symbol in one page in response to another user's corresponding command.

8. The user interface system of claim 1, further comprising a scrolling module to page up and down the channel symbols in response to another use's corresponding command.

9. A method for providing a program schedule for a television, the method comprising steps of:
searching for television channels, each television channel corresponding to one channel number and one channel logo; combining each channel number and the respective channel logo according to a predetermined rule to generate channel symbols for the associated television channels;
arranging the television symbols according to a predetermined pattern to generate a program schedule; and
displaying the program schedule in response to a user's command.

10. The method of claim 9, wherein after the step of generating channel symbols for the associated television channels, the method further comprising steps of dividing the channel symbols into different pages.

11. The method of claim 9, wherein the predetermined rule is arranging the channel number in or outside the channel logo.

12. The method of claim 9, wherein the predetermined pattern is arranging the channel symbols as a matrix.
